(19) United States
(12) Patent Application Publication
(10) Pub. No.: US 2008/0173462 A1
(43) Pub. Date: Jul. 24, 2008

(54) SPACER AND SPACER DAMPER

(75) Inventors: Robert Whapham, North Royalton, OH (US); John Olenik, Mentor, OH (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: PREFORMED LINE PRODUCTS COMPANY, Mayfield Village, OH (US)

(21) Appl. No.: 11/971,720

(22) Filed: Jan. 9, 2008

Related U.S. Application Data
(60) Provisional application No. 60/884,348, filed on Jan. 10, 2007.

(51) Int. Cl. H02G 7/12; H02G 7/14

(52) U.S. Cl. 174/42

(57) ABSTRACT

A spacer and/or spacer damper that provides for uniform spacing of horizontally bundled sub-conductors as well as enhanced heat dissipation is disclosed. More particularly, when applied to electrical transmission lines, the configuration of the spacer and/or spacer damper can include formed-wire outer rods which increase the conductor surface area thereby enhance heat dissipation. In other words, the outer rod assembly disclosed herein can provide for minimizing damaging effects of motion while enhancing heat dissipation of the underlying conductor and connector arm. Still further, the subject spacer or spacer damper can alleviate entangling of the sub-conductors most often caused by galloping, ice unloading, and fault currents.

### CROSS-REFERENCE TO RELATED APPLICATIONS

This application claims the benefit of U.S. Provisional Patent application Ser. No. 60/884,348 entitled “SPACER AND SPACER DAMPER APPARATUS” and filed Jan. 10, 2007. The entirety of the above-noted application is incorporated by reference herein.

### TECHNICAL FIELD

The subject innovation is generally directed to an apparatus (and corresponding method for installing same) that maintains a desired spacing of while suppressing motion and other undesirable vibrations and/or oscillations in aerial cables. More particularly, the subject innovation discloses a spacer and spacer damper that can maintain a desired spacing between conductor bundles while employing helically-wound formed-wire to increase strength while enhancing heat dissipation in the underlying conductor(s).

### BACKGROUND

In the utility industry, transmission lines are used to direct electrical energy from one location to another. These lines are used to transmit the energy over short or long distances as necessary or desired. Generally, the utility industry characterizes these lines into classes, such as high voltage lines less than 300 kilovolts (kV), extra high voltage (EHV) lines for voltages between 300 kV and 500 kV, and ultra high voltage (UHV) lines for voltages in excess of 500 kV.

Most often, EHV and UHV lines are employed to transfer power from a generating point to a distribution point. For example, these lines are used to transfer power from a generator step-up transformer to a substation(s) where the power will then be distributed to the distribution or load point. In practice, the transmission distance of energy upon EHV or UHV lines is often in excess of hundreds of miles. While uninterrupted delivery of energy is a primary objective, designers also consider economies of delivery when engineering transmission grids.

To economically design EHV and UHV transmission line systems, engineers often bundle the lines. While a bundled conductor increases efficiencies in design, there are a number of design challenges that arise when two or more conductors are tied together. As such, spacers and/or spacer-dampers are most often used to ensure sufficient separation of the conductors. In practice, spacers are used to ensure sufficient distance between conductors while spacer dampers additionally dampen any vibration in the lines while maintaining a suitable distance between the conductors or lines. By way of example, spacers and/or spacer dampers are most often employed at specified intervals along the span of a transmission line. In a specific example, a single transmission line that spans 2000 feet may have 8 or even 10 spacers evenly distributed along the span of the line. However, because transmission lines are most often employed in 3 phase configurations, there could be 24 to 30 spacers within this 2000 feet span which assist in maintaining required spacing arrangements in triangular, box or ring configurations.

As a result of experimental work done on some of the early EHV lines, the normal distance between conductors should not exceed a predetermined distance (e.g., 18 inches). However, in some geographical areas which are exposed to constant high winds and heavy ice accumulation, experience suggests that the spacing should be shortened or lengthened in order to further stabilize the conductor bundle.

Results of laboratory and field experiments have indicated that one of the most effective methods to reduce sub-conductor oscillation and to increase bundle stability is by reducing subspan lengths. This reduction in subspan length can be accomplished by placing spacers in a non-symmetrical pattern. Asymmetric spacing detunes the entire spacer-conductor system and thereby reduces the incidence of sympathetic vibration between subspans. However, specific recommendations for spacer design and spacer placement should be predicated on an evaluation of the electrical characteristics, the line design parameters, and the environmental conditions.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a semi-rigid spacer damper that provides for uniform spacing of horizontally bundled sub-conductors while efficiently dissipating heat from each of the sub-conductors. In particular embodiments, formed-wire outer rods (e.g., helically-formed or spiral-shaped rods) are employed to dissipate heat as well as to increase integrity of the conductors. In operation, the spacer or spacer damper of the subject innovation can maintain consistent electrical characteristics and minimize environmental (e.g., wind) induced motions such as sub-conductor oscillation and aeolian vibration so to minimize or eliminate conductor damage or fatigue. Still further, the subject spacer or spacer damper can prohibit the sub-conductors from entangling due to situations such as galloping, ice unloading, fault current, etc.

The spacer or spacer damper of the subject innovation can be employed in most any transmission line applications. For example, the spacer and spacer damper mechanisms can be employed in high temperature conductor applications as well as applications having substantial environmental effects. Within these applications, various arrangements can be employed in accordance with a particular application. In embodiments, ‘Twin, ‘Tri’, ‘Quad’ or ‘Hex’ arrangements can be employed in accordance with a specified number of conductors.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1A illustrates an example ‘Twin’ spacer or spacer damper configuration without the outer rods in accordance with an aspect of the innovation.

FIG. 1B illustrates an example ‘Tri’ spacer or spacer damper configuration without the outer rods in accordance with an aspect of the innovation.

FIG. 2 illustrates an example ‘Quad’ spacer or spacer damper configuration without the outer rods in accordance with an aspect of the innovation.

FIG. 3 illustrates an example ‘Hex’ spacer or spacer damper configuration without the outer rods in accordance with an aspect of the innovation.

FIG. 4 illustrates an example depiction of a spacer or spacer damper that employs formed-wire outer rods having heat dissipative properties in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

As described supra, the subject spacer or spacer damper mechanisms of the subject innovation can provide uniform spacing of horizontally bundled sub-conductors to establish consistent electrical characteristics while minimizing environmental effects, overheating and/or damage to the sub-conductors. For example, it will be appreciated that damage can occur as a result of wind induced motions such as sub-conductor oscillation and aeolian vibration. Similarly, excessive heat can cause damage to the conductors. As such, the subject mechanisms minimize these damaging effects as well as keep the sub-conductors from entangling due to galloping, ice unloading fault currents, etc.

As described herein, even though a high temperature elastomer could most often be used for the cushions within the apparatus, other acceptable materials that have been identified can limit the conductor operating temperature to 250° C. (or lower). Additionally, it will be understood that many of the high temperature conductor designs can be operated as high as 250° C. The addition of the helically-wound outer rods increases the conductivity in the area of the spacer and increase the radiating surface. Both the increased conductivity and increased radiating surface will reduce the temperature of the elastomer insert thereby allowing the conductor to operate at a higher temperature, such as 250° C. (or higher).

The addition of the outer rods also reduces the dynamic bending stresses on the conductors, which is necessary for high temperature conductors which have composite core materials that are sensitive to bending (e.g., ACCR (aluminum conductor composite reinforced) and ACCC (aluminum conductor composite core) conductors). These increased heat dissipation and strength (e.g., integrity) characteristics of the spherically-wound outer rods will be better understood upon a review of the figures that follow.

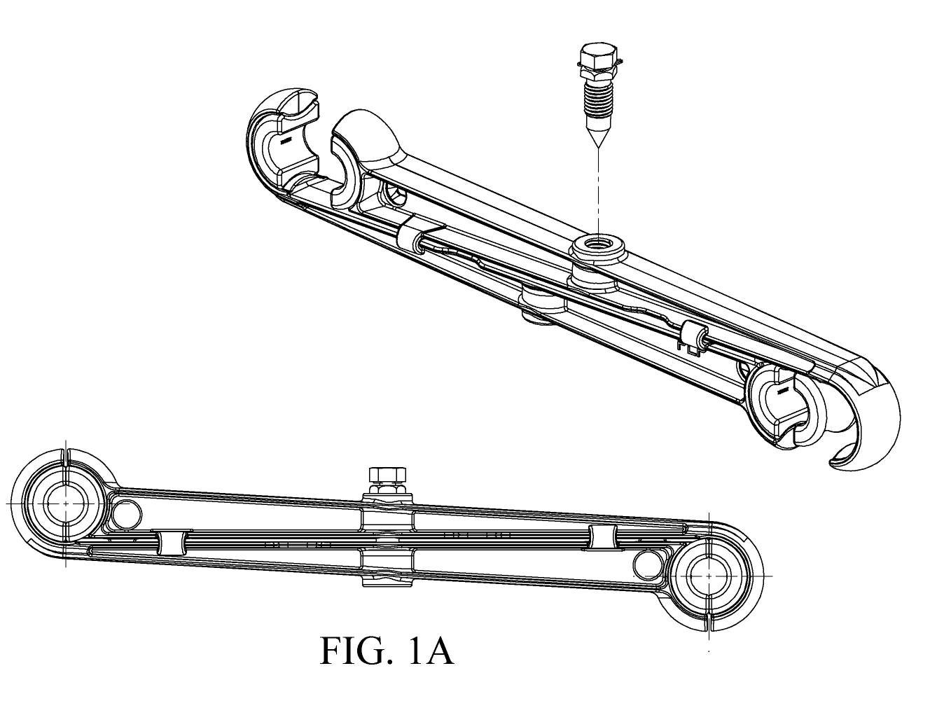

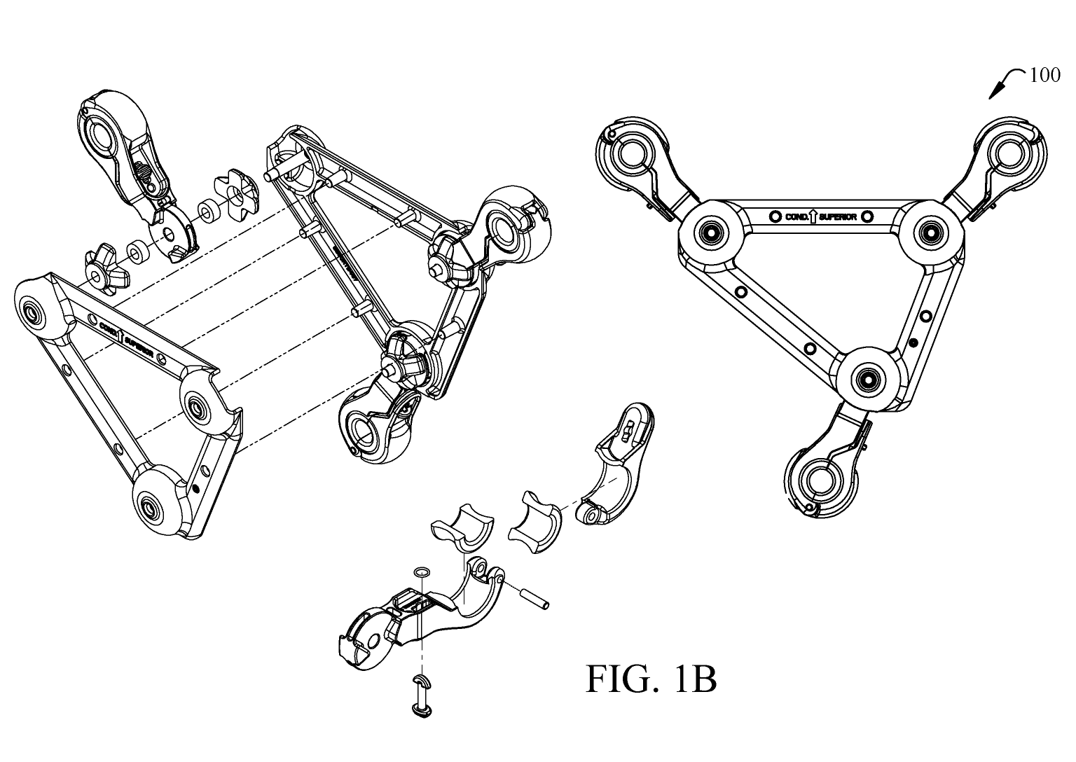

Although the spacer and spacer dampers shown in FIGS. 1A through 4 are applicable to most any electrical conductors, the features, functions and benefits of these devices can be most effectively realized when applied and employed in connection with a more recent technology of electrical conductors sometimes classified and known in the art as ‘high temperature, low sag’ conductors. These conductors are designed using, in many cases, composite materials which have a high strength and at the same time, a low coefficient of expansion, for example, to temperature. In addition to most any suitable conductor, the innovation is employed in connection with high temperature conductors which have composite core materials that are sensitive to bending, e.g., ACCR and ACCC conductors.

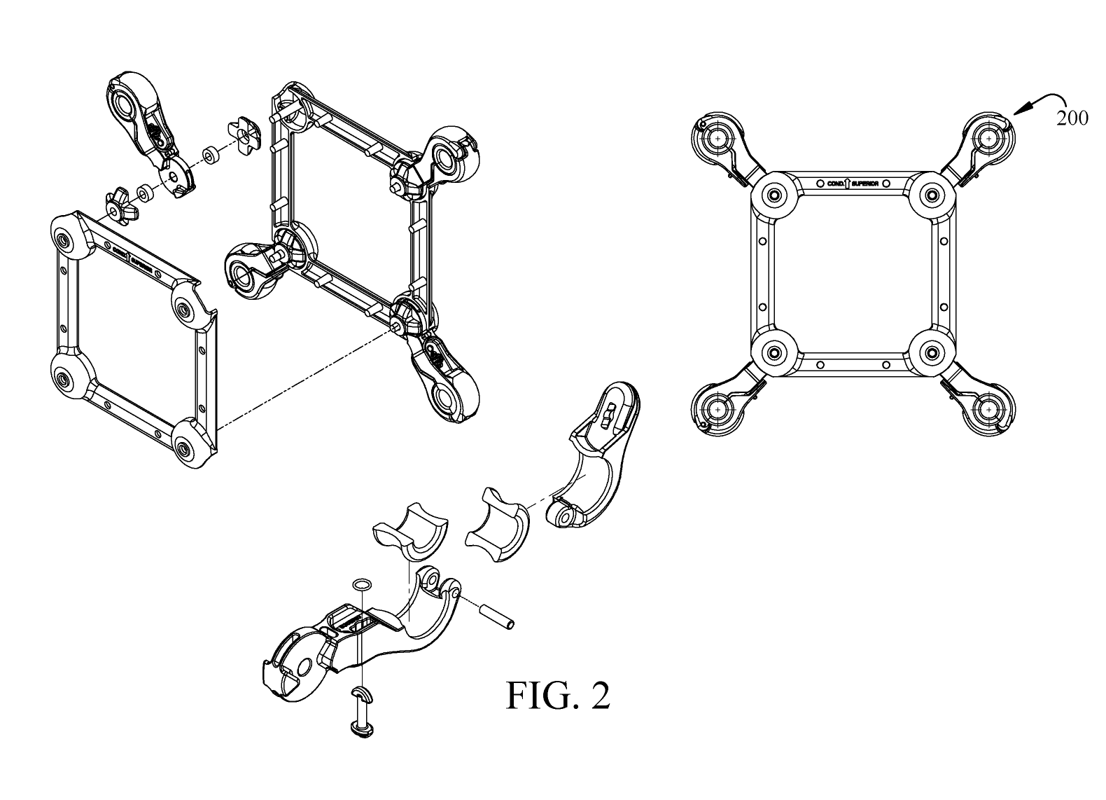

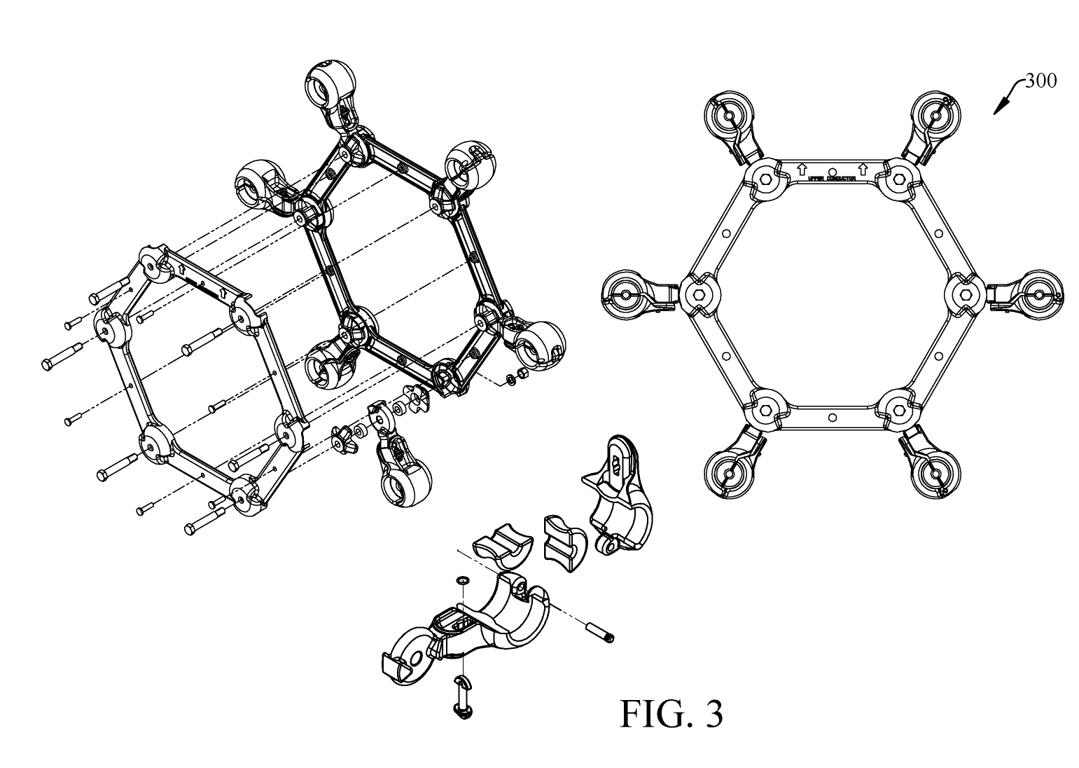

Referring now to the figures, FIGS. 1A and 1B illustrate example ‘cushion-grip’ spacer or spacer dampers 100 used in a twin- and tri-bundle arrangement respectively. While most of the discussion herein is directed to the tri-, quad- and hex-arrangement, it will be appreciated that the features of the innovation can be applied to a twin or two conductor system (FIG. 1A) without departing from the spirit and/or scope of the innovation and claims appended hereto. As will be described below, FIGS. 2 and 3 illustrate a quad-bundle and hex-bundle arrangements in accordance with alternative aspects. It is to be understood that the innovation can be applied to most any number of conductors without departing from the breadth of this specification. As well, although shown and described in connection with a ‘cushion-grip’ (e.g., elastomer insert) spacer, the features, functions and benefits of the formed-wire outer rods can be employed in connection with most any spacer and spacer damper known in the art without departing from the scope of this specification and claims appended hereto.

As illustrated in FIG. 1B, the body 1 can be configured in a ‘female’ configuration. This ‘female’ configuration can be described as having the body (e.g., housing) 1 constructed in such a way that that a mate with exposed connectors or body (e.g., ‘male’) can be inserted into the body 1 to effect a connection. While item 1 is shown as a ‘female’ housing, it is to be understood that, in other embodiments, this housing 1 can be constructed in a ‘male’ or otherwise ‘gender-neutral’ (e.g., flat) manner such that it effects connection with the opposite housing to form a uni-body as shown.

As shown in FIG. 1B, ‘female’ body 1 can connect to ‘male’ body 4 thereby effecting construction of the tri-bundle spacer-damper frame. Similarly, it will be understood that, in alternative aspects, bodies 1 and 4 can be constructed as a single unit without departing with the innovation. The bodies 1 and 4 can be constructed using most any suitable aluminum-alloy. As well, other metals, composites and alloys can be employed without departing from the scope of this specification.

In one aspect, a clamp arm can be secured (fixedly or adjustably) between ‘female’ and ‘male’ housings 1 and 4 so as to provide adequate pivotal movement to achieve desired spacing between conductors or lines. In doing so, a damping element(s) 2 and conductive insert(s) 3 can be used to secure and maintain the clamp arm into position. By way of example, the damping element 2 can have a four-pronged, cross or star shape (among other suitable shapes) which mates with the clamp arm in order to hold the clamp arm into a desired position. Details of an example clamp arm are described below. While a specific clamp arm is illustrated and discussed, it is to be understood that other suitable arrangements may exist in accordance with alternative aspects of the specification.

The damping element(s) 2 and conductive insert (3) can be constructed of most any suitable elastomer, neoprene, rubber, plastic or the like. For example, most any natural or synthetic compressive (e.g., rubber-type) material (e.g., polymer) can be used so long as the material exhibits properties capable of high temperature cushioning or dampening characteristics. While specific fastening arrangements are shown in FIG. 1B (and FIGS. 2 and 3 that follow), it is to be understood that alternative aspects employ other arrangements capable of the features, functions and benefits of the innovation. For example, other arrangements can be employed that, when used in conjunction with the spirally-configured outer rods described below, enable dampening, strength and thermal properties described herein,

With continued reference to FIG. 1B, an example assembly is shown. As illustrated, this example assembly has an 18″ centerline to centerline (or conductor to conductor) distance between clamp arms. While a specific dimension is shown, other aspects can be employed to retain an alternative distance between conductors as appropriate or desired. Similarly, if desired or appropriate, the clamp arms can be adjusted such that the centerline dimensions are not equidistant along each side of the spacer-damper.

Referring now to the exploded view of an example clamp arm, as shown in FIG. 1B, the clamp arm can generally be constructed using an arm 5 and a keeper 8, each of which can be constructed of aluminum-alloy or other suitably rigid (or semi-rigid) material. The arm 5 and the keeper 8 can be connected in a hinge-type fashion using pin 9. In one aspect the pin 9 can be constructed of a forged aluminum-alloy or other suitably rigid (or semi-rigid) material. Similarly, other attaching means (e.g., interlocking mechanisms, hook/catch) can be employed to connect arm 5 to keeper 8. Upon hinging into a ‘closed’ position around a conductor, a retainer pin 10 and elastomer grommet 6 (or other suitable locking mechanism) can be employed to secure the end opposite of the hinge to retain is a closed position.

As illustrated, an elastomer clamp liner 7 can be inserted into a suitable area of the arm 5 and keeper 8 in order to secure a conductor upon application. Although clamp liner 7 is illustrated as two symmetrical halves, it is to be understood and appreciated that other liner configurations can be employed without departing from the spirit and/or scope of the innovation. By way of example, in an alternative example, the clamp liner 7 can be constructed in a single ‘donut,’ or other cylindrical shape having a single separation or slot for installation upon to a conductor. While a cylindrical insert (or clamp liner 7) is shown in the figure, it is to be understood that the insert can be of any suitable shape so as to effect support of the conductor. For example, in another aspect, the insert can have a square or block exterior shape having a round or cylindrical groove within. Here, the cylindrical groove can effect grip upon a conductor while the exterior shape can provide for insert within an appropriate receiving area of a clamp arm. It is to be understood that the thickness and/or rigidity of the elastomeric materials described herein as well as their precise composition can be dependent upon a specific operating environment or desired application. In operation, the clamp liner 7 can be installed over the conductor by separating the single separation, and thereafter, the arm 5 and keeper 8 can be enclosed around the clamp liner 7 to complete installation.

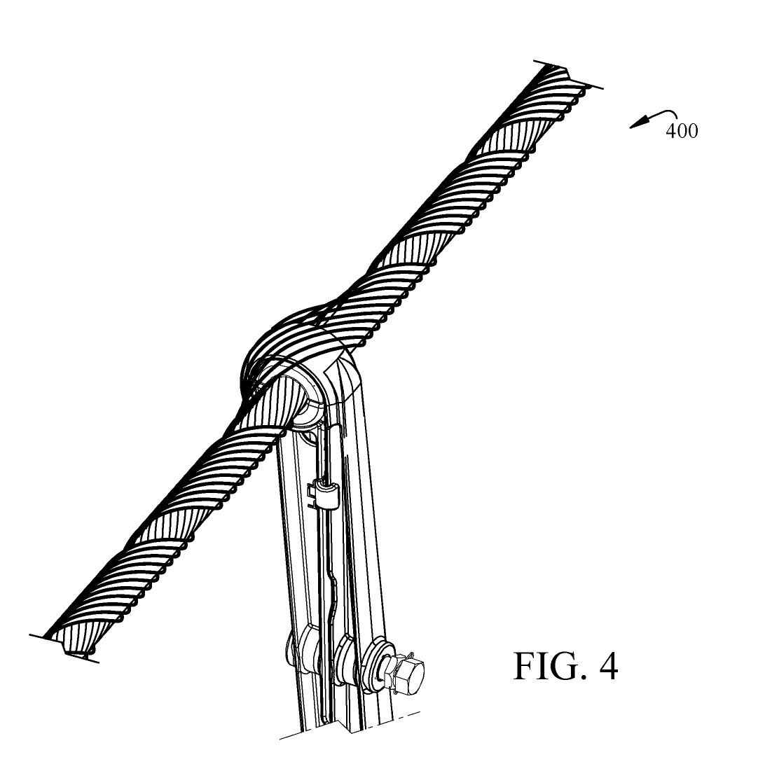

As described above, helical or spiral-wound outer rods can be employed to enhance thermal dissipation and strength characteristics of the conductors and space-damper. While these outer rods are discussed with reference to FIG. 4, FIGS. 2 and 3 that follow illustrate alternative arrangements of spacers and spacer dampers in accordance with alternative conductor arrangements. In particular, a quad-bundle and hex-bundle are described with reference to FIGS. 2 and 3 respectively that follow.

Referring now to FIG. 2, an alternative ‘quad-bundle’ arrangement 200 is shown in accordance with an aspect of the innovation. Essentially, the apparatus 200 can be constructed of the same or similar items as shown in FIG. 1B. Accordingly, like-numbered items have similar or the same descriptions as their counterparts in FIG. 1B. However, as illustrated in FIG. 2, in accordance with the ‘quad-bundle’ arrangement for use upon 4 conductors, the apparatus 200 employs an alternatively configured body assembly(ies) as well as additional clamp arm assembly as shown. As stated supra with reference to FIG. 1B, although an 18″ separation is employed, alternative spacing and/or separation can be employed as desired or appropriate.

Referring now to FIG. 3, an alternative ‘hex-bundle’ arrangement 300 is shown in accordance with an aspect of the innovation. Essentially, the apparatus 300 can be constructed of the same or similar items as shown in FIGS. 1A, 1B and 2. Accordingly, items having similar or the same descriptions as their like-named counterparts in FIGS. 1B and 2 can be described as set forth supra. However, as illustrated in FIG. 3, in accordance with the ‘hex-bundle’ arrangement for use upon 6 conductors, the apparatus 300 employs an alternatively configured body assembly(ies) as well as additional clamp arm assemblies as shown. As stated supra with reference to FIG. 1B, although a 15″ span is employed, alternative spacing and/or separation can be employed as desired or appropriate.

It is to be understood that these unique properties of apparatuses 100, 200 and 300 allow the specialty conductors to be used on existing transmission lines. More particularly, use of these specialty conductors on existing transmission lines allows for an increase in the allowable amount of power flow through the line without an increase in the conductor sag (e.g., stretch). This decrease in sag is particularly important as, most often, an increase in conductor sag could violate the clearance to ground (and other objects) spacing and/or distance that the line must maintain. This spacing and clearance distance is usually governmentally regulated and dictated by a regulatory body, e.g., the National Electrical Safety Code or NESC.

Because the composite materials used in many of the high temperature, low sag conductors have limited bending stress capability, these materials must be properly protected by the hardware used on these conductors. As such, the subject spacer and spacer damper (e.g., 100, 200, 300) has been designed in consideration of these potential issues. Thus, the unique configuration as illustrated in the figures can alleviate many (if not all) of the concerns associated therewith.

As described above, spacer and spacer dampers are most often employed with regard to transmission lines which operate at voltages of 230 kV, or above. Today, in the United States, transmission line voltages are as high as 765 kV. As will be understood, at higher voltages, a bundle of conductors is most often used for each phase, rather than a single conductor. This bundling can reduce or minimize the electrical (e.g., corona) and audible (e.g., noise) interference generated by the extremely high voltage on the conductors.

A typical bundle configuration can be described as a ‘Twin’ configuration (FIG. 1A) which can be in either a horizontal, vertical or diagonal arrangement. Additionally, other typical configurations can be described as a ‘Tri’, generally a triangle most often with apex down as shown in FIG. 1B (e.g., apparatus 100), ‘Quad’, generally square or diamond configuration as shown in FIG. 2 (e.g., apparatus 200), and ‘Hex’ which is generally circular as shown in FIG. 3 (e.g., apparatus 300). It is to be understood that the spacing between the sub-conductors in a bundle can vary on different lines as desired or appropriate.

Generally, spacers and spacer dampers are used in the spans between the supporting structures to maintain the shape of the bundle, and in the case of the spacer damper, to also dampen bundle motions caused by the wind and other environmental conditions. In a typical configuration, the spacers and spacer dampers are positioned at intervals within the span. For example, the devices are most often positioned within 150 feet to 200 feet intervals along the span, although spacing can vary as appropriate.

As illustrated in the figures, the subject spacer and spacer damper has elastomer (or other cushioning) elements deployed within in the junctions between the supporting frame and the clamp arms which connect to the sub-conductors. These elastomer elements absorb energy to dampen motions in the bundle created by the wind and other environmental conditions. These features are illustrated in FIGS. 1A through 3 which depict the ‘Twin,’ ‘Tri’, ‘Quad’ and ‘Hex’ spacer or spacer dampers respectively. It is to be understood that FIGS. 1A through 3 are provided to illustrate example spacer or spacer damper configurations as well as to highlight spacing and dampening characteristics. In other words, the spacers or spacer dampers are illustrated without the spiral-wound outer rods which are described herein and illustrated in the subsequent figure. Essentially, these outer rods can enhance integrity and heat dissipation by increasing the surface area around the clamp arm(s).

Concepts for a high temperature capable spacer and spacer dampers are shown in FIG. 4. These spacers and spacer dampers employ assemblies that are capable of enhancing mechanical performance and heat dissipation. As shown in the figure, a set of formed-wire outer rods (e.g., aluminum outer rods) are deployed around the conductor clamps which serve at least two purposes, increase strength and enhanced heat dissipation. It is to be appreciated that, although the rods described herein are constructed of aluminum, it is to be understood that the rods can be constructed of most any material (metal or alloy) of suitable strength having suitable heat dissipation characteristics. These alternative materials are to be included within the scope of this disclosure and claims appended hereto. Similarly, although the concepts of applying a formed-wire outer rod assembly to spacers and spacer dampers as described in FIGS. 1A through 3, it is to be appreciated that this outer rod assembly can be applied or used in conjunction with most any spacer and/or spacer damper known in the art so as to provide enhanced integrity and heat dissipation as described herein. Thus, these alternative applications are to be included within the scope of this disclosure and claims appended hereto.

First, as illustrated and deployed in FIG. 4, the position of the rods and the mechanical stiffness of the rods greatly reduce the amount of bending stress on the conductor when/if the conductor moves or vibrates. For example, these helically-wound or formed-wire outer rods can enhance integrity to address motion due to environmental conditions such as wind or other violent motions, for example, those created by a short circuit on the line. As described above, it will be understood and appreciated that it is particularly important to limit the bending stress on many of the high temperature, low sag conductors, due to their weakness to bending.

A second function, feature or benefit of the spiral-wound outer rods is to reduce the heating to the underlying conductor and/or spacer or spacer damper by creating a secondary path for the flow of electricity or electrical current. This secondary path creates an expanded surface area for the radiation of the heat away from the area. As described above, many high temperature, low sag conductors are designed to operate at temperatures as high as 250° C., which is generally twice as hot as a typical spacer or spacer damper is designed to withstand.

In other words, the highly conductive (e.g., aluminum or other suitable material) rods reduce the overall (e.g., conductor plus rods) electrical resistance in the area in which they cover. In turn, the I²R (current squared times resistance) heating is reduced in that region. The expanded surface area created by the aluminum rods also creates a radiator which inherently contributes to producing a cooling effect.

As described supra, the innovation discloses a spacer and spacer damper that can be used in connection with electrical transmission cables or the like. The described apparatus can be constructed of multiple mating half-sections as shown in the previously described figures. As well, the apparatus can be constructed of a single non-mating rigid frame. As shown, elastomer inserts can be employed within the clamp arm assembly to grip the individual cables to provide adequate dampening support. While elastomer materials are discussed supra, it is to be understood that most any suitable material including, but not limited to, neoprene, plastic, rubber or the like can be employed in alternative aspects.

While the structure of the apparatus described with reference to FIGS. 1 through 3 can provide for predetermined spacing, cushioning and damping of motion related to aerial cables, FIG. 4 illustrates yet another benefit that can be employed in accordance with the subject specification, namely, helically-wound outer rods that provided enhanced heat dissipation in the underlying conductors as well as to the spacer and/or spacer damper. As it will be understood that vibration between sub-conductors, torsional oscillations, excessive swaying and impact between conductors can cause damage to the lines, support structures, spacers, etc., excessive temperatures too can cause similar undesirable effects.

The example embodiment relates to appliances for linear bodies and, more particularly, is directed to a new and improved dead-end appliance for use with linear bodies. It finds particular application in conjunction with high temperature linear bodies such as high temperature power transmission and distribution line wires, cables, and the like, and will be described with particular reference thereto. However, it is to be appreciated that the present exemplary embodiment is also amenable to other applications such as, for example, use in the construction arts for buildings, bridges and other structures, in manufacture and anywhere there is a need for connection with substantially linear bodies.

With reference again to FIG. 4, it is to be understood that the helically-wound outer rod assembly that is disposed around the conductor end of the clamp arm can enhance protection of the conductor (e.g., ACCR conductor) when subjected to high temperatures in addition to vibration and other movement. It is understood that conductors under tension can vibrate in standing waves when subjected to laminar wind flows. Additionally, it is well understood that conductors can achieve elevated temperatures when under continuous operation. Here, by increasing the surface area with the helically-wound rods, heat can be dissipated more efficiently and effectively thereby reducing damage and/or failure caused by elevated temperatures. Moreover, the additional rod assembly which spans across the clamp arm provides additional support for the cable in undesirable movement or oscillation.

It is to be appreciated that bending stresses that can be caused by vibration activity at the clamp arm can be reduced by the additional support of the helically-wound outer rods. As will be understood, if the conductor is not properly protected from vibration (e.g., aeolian vibration) and other movement, fatigue failures can occur. These features, functions and benefits will be appreciated by those skilled in the art.

Still further, the helically-wound overlay rods can be terminated with a standard cut and de-burred rod ends. In other aspects, a ‘ball end’ treatment can be applied to the rod ends. This ‘ball end’ treatment can effect an assembly that is corona free (or near corona free) to a line to ground voltage. Most often, this ‘ball end’ treatment will be used for applications up to and including 230 kV. For 345 kV and higher, a ‘parrot-bill’ rod end treatment can be used to enhance electrical properties and performance characteristics.

As illustrated in FIG. 4, the helically-wound wires or rods can be applied to the conductor on each side of the clamp arm. In other words, a continuous helically-wound assembly can be applied to one side of the clamp end, continue over the ‘knuckle’ of the clamp arm and continue to an equidistant (or similar) distance upon the conductor on the other side of the clamp arm. As shown, the helically-wound assembly covers the circumference of the conductor and the clamp arm. In one aspect, the assembly is constructed of an aluminum-alloy which provides for enhanced strength while increasing the surface area to maintain (or otherwise achieve) an operating temperature lower than the core conductor itself.

Here, heat can be dissipated by way of the increased surface area in a direction outwardly from the clamp arm. As will be understood and appreciated, this radiator effect can contribute to enhance apparatus life as well as reliability. By wrapping the conductor as well as the conductor-end of the clamp arm with the helically-wound assembly, strength as well heat dissipative characteristics can be greatly enhanced.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A transmission line spacing system, comprising:
means for spacing a plurality of sub-conductors from each other; and
means for maintaining a suitable operating temperature.

2. The transmission line spacing system of claim 1, wherein the means for maintaining the suitable operating temperature is a helically-wound assembly that at least partially wraps a portion of the sub-conductor at a point of connection to the means for spacing.

3. The transmission line spacing system of claim 2, wherein the helically-wound assembly includes a plurality of formed-wire outer rods.

4. The transmission line spacing system of claim 3, wherein each of the plurality of formed-wire outer rods is an aluminum-alloy rod.

5. The transmission line spacing system of claim 4, wherein each of the plurality of formed-wire outer rods is terminated with a ‘ball-end’ rod treatment.

6. The transmission line spacing system of claim 4, wherein each of the plurality of formed-wire outer rods is terminated with a ‘parrot-bill’ rod treatment.

7. The transmission line spacing system of claim 1, further comprising means for damping vibration in each of the plurality of sub-conductors.

8. The transmission line spacing system of claim 7, wherein the means for damping vibration in each of the plurality of sub-conductors is an elastomer insert.

9. The system of claim 1, further comprising means for increasing the integrity of each of the plurality of sub-conductors.

10. The system of claim 9, wherein the means for increasing the integrity of each of the plurality of sub-conductors is a helically-wound assembly that at least partially wraps a portion of the sub-conductor at a point of connection to the means for spacing.

11. The system of claim 1, the plurality of sub-conductors are arranged in at least one of a ‘Twin, ‘Tri’, ‘Quad’ or ‘Hex’ configuration.

12. The system of claim 1, the sub-conductors are at least one of a 3M ACCR-brand or a CTC ACCC-brand conductor.

13. A method for achieving enhanced heat dissipation of an elongate conductor applied to a spacer, comprising:
establishing a connection point that rigidly positions a first conductor from a second conductor;
securing the first conductor at the connection point; and
wrapping the connection point and a portion of the first conductor with a plurality of helically-wound outer rods, wherein the plurality of helically-wound outer rods increase conductor surface area.

14. The method of claim 13, wherein each of the plurality of helically-wound outer rods is an aluminum-alloy rod.

15. The method of claim 13, wherein the act of wrapping the connection point and a portion of the first conductor includes complete circumference wrapping of the portion of the first conductor.

16. The method of claim 13, further comprising damping vibration in each of the first and second conductor.

17. A system that facilitates spacing, dampening and heat dissipation in a plurality of conductors, comprising:
a first half-body frame having at least two ends or apexes;
a second half-body frame having at least two ends or apexes, wherein the second half-body frame mates to the first half-body frame to establish a uni-body, wherein the uni-body is capable of rigidly spacing each of the plurality of conductors;
a plurality of clamp arms each having an elastomer insert that is capable of gripping a conductor on one end, wherein the clamp arms are pivotably disposed between each end or apex of the first and second half-body frames; and
a spiral-wound outer rod assembly that at least partially wraps a portion of each clamp arm as a point of grip to the conductor.

18. The system of claim 17, further comprising an elastomer insert that is disposed within the conductor end of the clamp arm and provides dampening characteristics to reduce vibratory effect.

19. The system of claim 17, each of the plurality of conductors is at least one of an ACCR or an ACCC conductor.

20. The system of claim 17, wherein the spiral-wound outer rod assembly includes a plurality of aluminum-alloy rods.
